(19) United States
(12) Patent Application Publication
(10) Pub. No.: US 2026/0245813 A1
(43) Pub. Date: Aug. 20, 2026

(54) KEYBOARD AND KEY MODULE THEREOF

(71) Applicant: CHICONY ELECTRONICS CO., LTD., New Taipei City (TW)

(72) Inventor: Kuang-Shen UANG, New Taipei City (TW)

(21) Appl. No.: 19/640,995

(22) Filed: Apr. 7, 2026

Related U.S. Application Data
(62) Division of application No. 18/411,848, filed on Jan. 12, 2024.

(30) Foreign Application Priority Data
Jan. 19, 2023 (TW) 112102584

(51) Int. Cl. H01H 13/7057; H01H 13/803; H01H 13/84

(52) U.S. Cl. CPC H01H 13/7057; H01H 13/803; H01H 13/84; H01H 2231/008

(57) ABSTRACT

A keyboard includes a fixed module and at least one key module. The fixed module includes a first circuit board and a first base plate. The first circuit board includes a trigger unit. The first base plate includes an accommodation space, and the trigger unit corresponds to the accommodation space. The key module is detachably disposed on the fixed module. The key module includes a keycap unit, a second base plate, a connecting member and an elastic member. The keycap unit partially corresponds to the accommodation space of the first base plate. The second base plate detachably connects to the fixed module. One end of the connecting member connects to the keycap unit, and the other end of the connecting member connects to second base plate. The elastic member is disposed on the second base plate and in contact with the keycap unit.

### CROSS-REFERENCE TO RELATED APPLICATION

This application is a Divisional of co-pending application Ser. No. 18/411,848, filed on Jan. 12, 2024, and for which priority is claimed under 35 U.S.C. § 120, and this application claims the priority benefit of Taiwan application serial No. 112102584, filed on Jan. 19, 2023. The entirety of the above-mentioned patent application is hereby incorporated by reference herein and made a part of this specification.

### BACKGROUND

### 1. Technical Field

This disclosure relates to a keyboard, specifically to a replaceable key structure of a keyboard.

### 2. Description of the Related Art

In terms of current computer usage habits, a keyboard is one of the indispensable input devices. A keyboard is composed of multiple key structures, and users choose different types of key structures based on varying needs. Taking gaming keyboards designed for gaming as an example, compared to general keyboards used for processing documents or other tasks, their main requests include offering good tactile feedback and quick signal transmission when pressing the keys, adding new keys for special functions, or avoiding ghosting when pressing more than one keys simultaneously, to enable players to operate more swiftly and conveniently.

Esports gamers might also choose keyboards with different types of key structures based on different gaming scenarios. For example, in a racing game scenario, a key structure with an inclined keycap might be selected. Generally, the esports gamers tend to choose gaming keyboards, and they may even purchase more than one keyboard to meet different needs. However, having multiple keyboards with different key structures just to meet specific usage needs or gaming scenarios is quite inconvenient, and there is room for improvement.

### SUMMARY

In view of the above-mentioned problems, the main object of the disclosure is to provide a keyboard and a key module thereof, the key module is replaceable, to address the issue of conventional keyboards being unable to meet user needs by replacing different key structures.

In order to achieve the above object, this disclosure provides a keyboard, which comprises a fixed module and at least one key module. The fixed module comprises a first circuit board and a first base plate. The first circuit board comprises a trigger unit. The first base plate comprises an accommodation space, and the trigger unit corresponds to the accommodation space. The key module is detachably set on the fixed module. The key module comprises a keycap unit, a second base plate, a connecting member, and an elastic member. A portion of the keycap unit corresponds to the accommodation space of the first base plate. The second base plate detachably connects to the fixed module. One end of the connecting member connects to the keycap unit, and the other end connects to the second base plate. The elastic member is set on the second base plate and is in contact with the keycap unit.

To achieve the aforementioned objective, this disclosure provides a key module, which is applied to a keyboard. The keyboard comprises a fixed module, and the fixed module comprises a first base plate. The feature is that the key module is detachably disposed on the fixed module, and the key module comprises a keycap unit, a second base plate, a connecting member, and an elastic member. A portion of the keycap unit corresponds to an accommodation space of the first base plate. The second base plate detachably connects to the fixed module. One end of the connecting member connects to the keycap unit, and the other end of the connecting member connects to the second base plate. The elastic member is disposed on the second base plate and is in contact with the keycap unit.

In an embodiment of the present disclosure, the second base plate detachably connects to the first base plate.

In an embodiment of the present disclosure, the second base plate comprises a propped portion. The second base plate is accommodated in the accommodation space of the first base plate, and the propped portion abuts against the first base plate.

In an embodiment of the present disclosure, the fixed module and the key module are connected by magnetic attraction.

In an embodiment of the present disclosure, the connecting member comprises a scissor-type connecting member, a linkage, or a connecting plate.

In an embodiment of the present disclosure, the second base plate comprises a main body and a reinforcement piece. The reinforcement piece is set inside the main body.

In an embodiment of the present disclosure, the reinforcement piece comprises a limiting portion, and the connecting member connects to the limiting portion.

In an embodiment of the present disclosure, the second base plate further comprises a pivot. The pivot and the elastic member are disposed on two opposite sides of the second base plate. One side of the keycap unit connects to the pivot.

In an embodiment of the present disclosure, the elastic member contacts another side of the keycap unit and pushes the keycap unit upwards, making one surface of the keycap unit inclined.

In an embodiment of the present disclosure, the second base plate comprises a limiting portion. The limiting portion is disposed between the pivot and the elastic member, and the connecting member connects to the limiting portion.

In an embodiment of the present disclosure, the keycap unit comprises a keycap and a junction member. The keycap movably connects to the junction member, and the connecting member connects to the junction member.

In an embodiment of the present disclosure, the keycap comprises a bottom surface and a first hook. The first hook is spaced apart from the bottom surface. The junction member comprises a second hook, and the first hook and the second hook are abutted each other.

In an embodiment of the present disclosure, the key module also comprises a telescopic sleeve. The telescopic sleeve is disposed between the second base plate and the keycap. The elastic member is accommodated within the telescopic sleeve, and one end of the elastic member contacts the keycap.

In an embodiment of the present disclosure, the elastic member is a telescopic sleeve. One end of the telescopic sleeve is disposed on the second base plate, and the other end of the telescopic sleeve connects to the keycap unit.

In an embodiment of the present disclosure, the fixed module further comprises a second circuit board disposed above the first base plate.

In an embodiment of the present disclosure, the key module further comprises a third circuit board disposed above the second base plate.

In an embodiment of the present disclosure, the fixed module comprises a plurality of key structures, which connects to the first base plate.

In an embodiment of the present disclosure, the second base plate comprises an accommodating hole corresponding to the elastic member. The trigger unit is a force sensor disposed below the accommodating hole.

In an embodiment of the present disclosure, the key module further comprises a fixed member. The fixed member is disposed in the accommodating hole of the second base plate, and a portion of the elastic member in contact with the fixed member.

In an embodiment of the present disclosure, the fixed member is a cover structure disposed within the accommodating hole.

In an embodiment of the present disclosure, the accommodating hole has a sidewall top surface. The cover structure has an extending portion extending outward. The extending portion is disposed above the sidewall top surface of the accommodating hole, and there is a gap between the extending portion and the sidewall top surface.

In an embodiment of the present disclosure, the fixed member is a fixed film. The fixed film connects to a surface of the second base plate facing the first circuit board and covers at least a portion of the accommodating hole. The elastic member comprises a bottom and a trigger portion, the bottom is disposed on the fixed film, and the trigger portion corresponds to the trigger unit.

In an embodiment of the present disclosure, the fixed module further comprises a bracket. The bracket is disposed on a surface of the first base plate opposite to the key module and corresponds to the accommodation space. The first circuit board is disposed on the bracket.

In an embodiment of the present disclosure, the bracket and the key module are connected by magnetic attraction.

Continuing from the above, according to the keyboard and key module applied to the keyboard of this disclosure, the keyboard comprises a fixed module and at least one said key module. The fixed module comprises a first circuit board and a first base plate. The first circuit board comprises a trigger unit, and the first base plate comprises an accommodation space. Additionally, the key module comprises a keycap unit and a second base plate. The trigger unit and a portion of the keycap unit correspond to the accommodation space, allowing the trigger unit to sense the displacement of the keycap unit and generate a trigger signal. Furthermore, the key module detachably connects to the fixed module via the second base plate, so that the key module can be a replaceable key module. Therefore, the keyboard of this disclosure can accommodate different usage needs by replacing with different key modules, thereby improving the user experience.

### BRIEF DESCRIPTION OF THE DRAWINGS

FIG. 1 is a schematic diagram of a keyboard according to a first embodiment of the disclosure;

FIG. 2 is an exploded schematic diagram of the keyboard shown in FIG. 1;

FIG. 3 is an exploded schematic diagram of the fixed module and key module shown in FIG. 2;

FIG. 4 is a schematic diagram of a key module according to a second embodiment of the disclosure;

FIG. 5 is an exploded schematic diagram of the key module shown in FIG. 4;

FIG. 6 is a schematic diagram of a key module according to a third embodiment of the disclosure;

FIG. 7 is an exploded schematic diagram of the key module shown in FIG. 6;

FIG. 8 is a sectional schematic diagram of the key module shown in FIG. 6;

FIG. 9 is an exploded schematic diagram of a keyboard according to a fourth embodiment of the disclosure;

FIG. 10 is a schematic diagram of the first circuit board and the key module shown in FIG. 9;

FIG. 11 is an exploded schematic diagram of the first circuit board and the key module shown in FIG. 10;

FIG. 12 is an exploded schematic diagram of the keyboard of the fifth embodiment of the present disclosure;

FIG. 13 is a sectional schematic diagram of the keyboard shown in FIG. 12 after assembly, illustrating one of the key modules;

FIG. 14 is a schematic diagram of the key module shown in FIG. 12;

FIG. 15 is an exploded schematic diagram of the key module shown in FIG. 14;

FIG. 16 is a sectional schematic diagram of a partial keyboard of the sixth embodiment of the present disclosure;

FIG. 17 is a schematic diagram of the key module shown in FIG. 16; and

FIG. 18 is an exploded schematic diagram of the key module shown in FIG. 16.

### DETAILED DESCRIPTION OF THE EMBODIMENTS

In order to make the structure, characteristics, and effectiveness of the disclosure further understood and recognized, a detailed description of the disclosure is provided as follows, along with embodiments and accompanying figures.

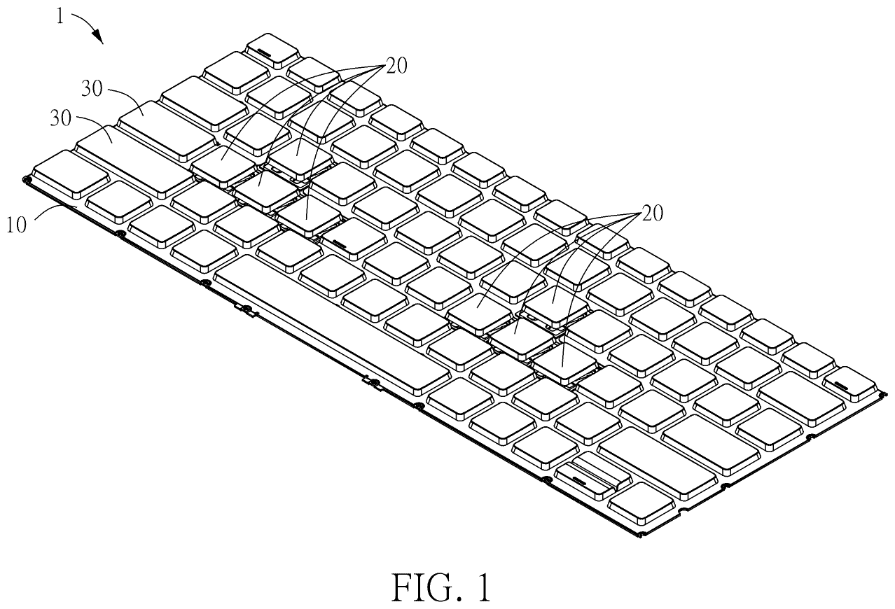

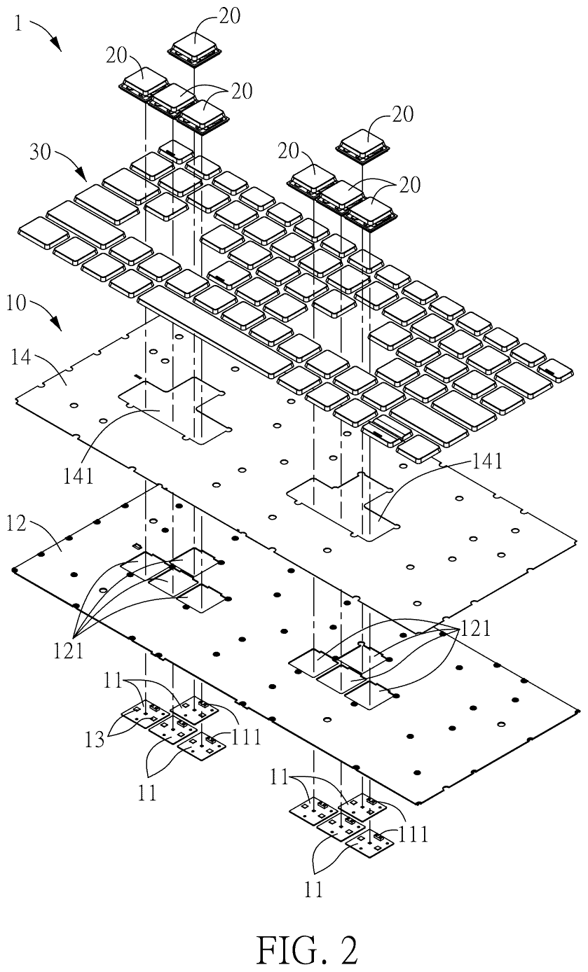

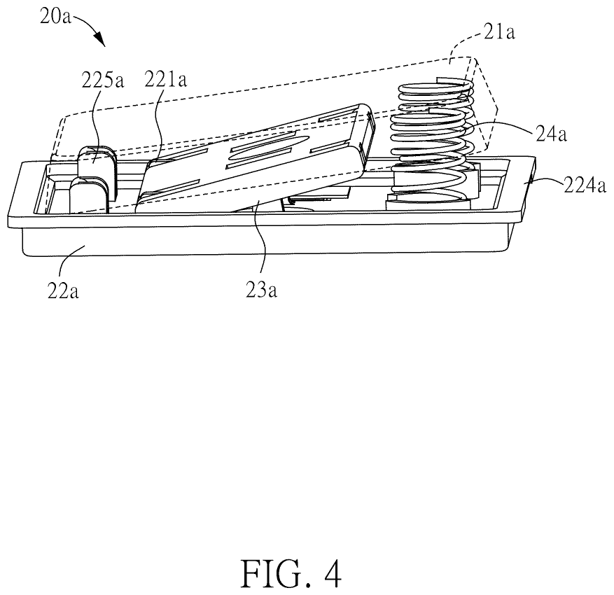

FIG. 1 is a schematic diagram of a keyboard according to a first embodiment of the disclosure; and FIG. 2 is an exploded schematic diagram of the keyboard shown in FIG. 1. Refer to FIG. 1 and FIG. 2. In this embodiment, the keyboard 1 comprises a fixed module 10 and at least one key module 20. The key module 20 is detachably disposed on the fixed module 10. This means that the key module 20 in this embodiment is a replaceable key module 20, which can be easily swapped out for other types of key modules (refer to FIG. 4 for an example of key module 20a). Specifically, this embodiment of the keyboard 1 further comprises a plurality of key structures 30, which are disposed on the fixed module 10 and are not replaceable with other types of key structures 30. Preferably, most keys of keyboard 1 are non-replaceable key structures 30, with replaceable key modules 20 used for certain special function keys. For example, in gaming, the ‘WASD’ (or ‘ESDF’), or ‘IJKL’ keys, which are often used for up, down, left, and right movements, could use replaceable key modules 20.

As shown in FIG. 2, the fixed module 10 of this embodiment comprises at least one first circuit board 11 and a first base plate 12. It should be noted that in this embodiment, the first circuit board 11 is designed as eight separate first circuit boards 11 according to the number of key modules 20, to correspond respectively to the ‘WASD’ (or ‘ESDF’), and ‘IJKL’ key positions. In other embodiments, the eight first circuit boards 11 could be combined into one or two first circuit boards 11; the present disclosure is not limited thereto. The first circuit board 11 comprises at least one trigger unit 111. Similarly, the number and position of the trigger units 111 correspond to the key modules 20, used to detect the operation of the key modules 20.

The first base plate 12 is a rigid board, for general types of key structures 30 fixing. In this embodiment, the first base plate 12 is a metal piece. Additionally, the first base plate 12 is disposed adjacent to the first circuit board 11. Preferably, the first base plate 12 is adhesively connects to the first circuit board 11. In this embodiment, the first base plate 12 is disposed above the first circuit board 11, and an adhesive can be placed on the bottom side of the first base plate 12 to adhere the first base plate 12 to the first circuit board 11. The first base plate 12 comprises at least one accommodation space 121. In this embodiment, there are eight accommodation spaces 121 as examples, each corresponding to individual key modules 20. In other embodiments, there may also be two accommodation spaces 121, each corresponding to the ‘WASD’ (or ‘ESDF’), and ‘IJKL’ key positions of key modules 20. Preferably, the accommodation spaces 121 in this embodiment can be openings, allowing the trigger units 111 to be disposed within the accommodation spaces 121 to detect the operation of the replaceable key modules 20. In other embodiments, the first base plate 12 can also be disposed below the first circuit board 11, and the accommodation spaces 121 can be a recessed structure. The trigger units 111 can similarly be disposed within the accommodation spaces 121 to detect the operation of the replaceable key modules 20 and generate corresponding input signals. The detailed structure of the key module 20 and the details of how the trigger unit 111 generates input signals will be described below.

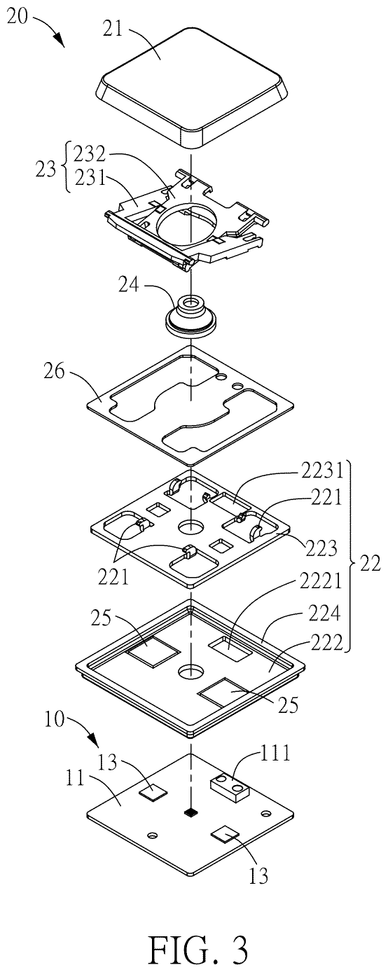

FIG. 3 is an exploded schematic diagram of the fixed module and key module shown in FIG. 2. It should be noted that because the fixed module 10 corresponds to the key module 20 mostly as holes (such as the accommodation spaces 121 of the first base plate 12), FIG. 3 only shows the structure of the first circuit board 11 of the fixed module 10. As shown in FIG. 3, in this embodiment, the key module 20 comprises a keycap unit 21, a second base plate 22, a connecting member 23, and an elastic member 24. One end of the connecting member 23 connects to the keycap unit 21, and the other end of the connecting member 23 connects to the second base plate 22. In other words, the keycap unit 21 and the second base plate 22 are connected via the connecting member 23. In this embodiment, the connecting member 23 is a scissor-type connecting member, including an outer frame 231 and an inner frame 232 pivoted to each other. One end of the outer frame 231 and one end of inner frame 232 connect to the keycap unit 21 and the other end of outer frame 231 and the other end of inner frame 232 connect to the second base plate 22. In this embodiment, the second base plate 22 has at least one limiting portion 221, such as a hook, for connecting one end of the outer frame 231 and one end of the inner frame 232. The outer frame 231 and inner frame 232 move the keycap unit 21 relative to the second base plate 22. The connection of the scissor-type connecting member (e.g., connecting member 23) to the base plate (e.g., second base plate 22) and the keycap (e.g., keycap unit 21), and the resultant lifting action are common knowledge in the technical field of this disclosure and are not elaborated here.

In one embodiment, the material of the second base plate 22 can be plastic to achieve the purpose of being lightweight and easy to manufacture. Preferably, the second base plate 22 of this embodiment comprises a main body 222 and a reinforcement piece 223, with the reinforcement piece 223 disposed inside the main body 222. Preferably, the reinforcement piece 223 can be made of a metal material with higher strength. The limiting portion 221 is located at the reinforcement piece 223, meaning that the reinforcement piece 223 comprises the aforementioned limiting portion 221. The connecting member 23 (i.e., the outer frame 231 and inner frame 232) connects to the limiting portion 221. Due to the higher strength of the reinforcement piece 223, it can increase the durability of the key module 20.

Furthermore, the second base plate 22 detachably connects to the fixed module 10. In this embodiment, the accommodation space 121 of the first base plate 12 (as shown in FIG. 2) can accommodate the second base plate 22, allowing the second base plate 22 to detachably connect to the first base plate 12. Preferably, the second base plate 22 comprises a propped portion 224, which protrudes outward from the outer wall of the second base plate 22. In this embodiment, the propped portion 224 can surround the periphery of the main body 222 and protrude outward, as shown in FIG. 3. As shown in FIG. 2, the shape of the accommodation space 121 of the first base plate 12 corresponds to the shape of the second base plate 22, so that the second base plate 22 can be accommodated in the accommodation space 121. In this embodiment, the shape of the accommodation space 121 corresponds to the shape of the main body 222 of the second base plate 22, such as a quadrilateral, allowing the main body 222 to be accommodated in the accommodation space 121. When the second base plate 22 is accommodated in the accommodation space 121 of the first base plate 12, the propped portion 224 abuts against the upper surface of the first base plate 12, so that the second base plate 22 can be disposed in the accommodation space 121 of the first base plate 12, thereby setting the key module 20 on the fixed module 10. In other embodiments, the fixed module 10 can have a frame, which can have a plurality of accommodation spaces for placing the key modules 20 and the key structures 30. The key module 20 can also detachably connects to the frame, and the disclosure is not limited thereto.

Preferably, the fixed module 10 and the key module 20 of this embodiment can be connected by magnetic attraction. In one embodiment, the fixed module 10 further comprises at least one first magnetic member 13, and the key module 20 further comprises at least one second magnetic member 25. The first magnetic member 13 is disposed on the first circuit board 11, and the second magnetic member 25 is disposed on the second base plate 22, such as at the main body 222. When the key module 20 is placed in the accommodation space 121 of the first base plate 12, the first magnetic member 13 and the second magnetic member 25 attract each other, thereby detachably fixing the key module 30 to the fixed module 10. In other words, the second base plate 22 can also detachably connects to the first circuit board 11 of the fixed module 10.

Additionally, the elastic member 24 is disposed on the second base plate 22 and contacts the keycap unit 21. In this embodiment, the top end of the elastic member 24 contacts the bottom side of the keycap unit 21 to provide the force for the keycap unit 21 to return to its original position. The elastic member 24 of this embodiment is made of rubber and is a rubber dome. In other embodiments, the elastic member 24 may be a spring, metal spring clip, metal dome, or telescopic sleeve, and the present disclosure is not limited thereto.

When the key module 20 is disposed on the fixed module 10, a part of the keycap unit 21 corresponds to the accommodation space 121 of the first base plate 12, allowing the trigger unit 111 of the first circuit board 11 to detect the height change of the keycap unit 21, thereby generating a corresponding input signal. Specifically, the trigger unit 111 of this embodiment can be an optics sensor, such as a reflective optics sensor. In other embodiments, the trigger unit 111 can also be a force sensor, inferring the position of the keycap unit 21 by sensing changes in force. When the keycap unit 21 is pressed, the trigger unit 111 can detect the height or position change of the keycap unit 21, thereby generating a corresponding input signal. Preferably, the main body 222 and the reinforcement piece 223 of the second base plate 22 each have a hole 2221, 2231 to accommodate the trigger unit 111. In this embodiment, the trigger unit 111 is located at the central position of one side of the first circuit board 11. Correspondingly, the holes 2221, 2231 are located at the central position of one side of the main body 222 and the reinforcement piece 223, respectively.

It should be noted that, in this embodiment, the trigger unit 111 of the first circuit board 11 detects the operation of the replaceable key module 20, thereby generating input signals for the key module 20. Preferably, the fixed module 10 in this embodiment further comprises a second circuit board 14 for triggering other general types of key structures 30. Specifically, the key structure 30 connects to the first base plate 12, and the second circuit board 14 is disposed above the first base plate 12. The second circuit board 14 has two openings 141 corresponding to the position of the replaceable key module 20. The first base plate 12 may comprise a plurality of card hooks (not shown in the figures) for connecting the key structure 30. The second circuit board 14 may include a plurality of membrane switches (not shown in the figures) to individually trigger each key structure 30. For the sake of simplicity in the drawings, hooks and membrane switches are not depicted in FIG. 2. When the key structure 30 is pressed, the membrane switches on the second circuit board 14 can be triggered to generate corresponding input signals. Preferably, the second circuit board 14 can be a membrane circuit board.

Preferably, the key module 20 further comprises a third circuit board 26, which is disposed above the second base plate 22. In this embodiment, the third circuit board 26 is disposed above a reinforcement piece 223 of the second base plate 22. Preferably, the third circuit board 26 can also be a membrane circuit board and can be used for triggering by the elastic member 24 with a rubber dome. In other words, depending on the type of elastic member 24, the third circuit board 26 may be additionally provided. Specifically, when the elastic member 24 is a rubber dome, you can choose to install the third circuit board 26 to generate input signals, or directly generate input signals by the trigger unit 111 of the first circuit board 11. When the elastic member 24 is a spring, the position of the keycap unit 21 can be detected by the trigger unit 111 of the first circuit board 11 to generate input signals without the need for an additional third circuit board 26.

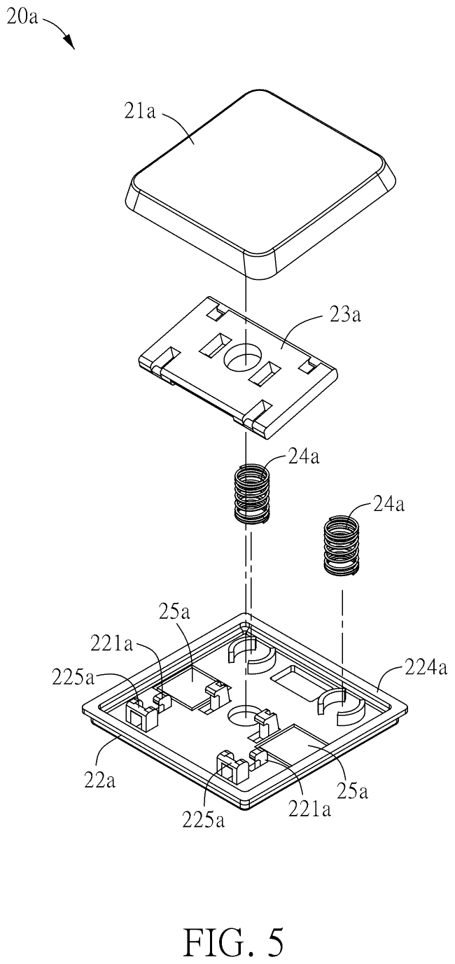

FIG. 4 is a schematic diagram of the key module of the second embodiment of the present disclosure; and FIG. 5 is an exploded schematic diagram of the key module shown in FIG. 4. Refer to FIG. 4 and FIG. 5. The key module 20a in this embodiment is suitable for gaming (further described later). Therefore, when a user is performing general word processing, the key module 20 of the first embodiment can be used (as shown in FIG. 2). When playing computer games, the key module 20 of this embodiment can be replaced with the key module 20a of the present embodiment, depending on different needs.

In this embodiment, the key module 20a comprises a keycap unit 21a, a second base plate 22a, a connecting member 23a, and an elastic member 24a. The second base plate 22a of this embodiment is a unitary component, preferably made of plastic material. In contrast to the first embodiment, the second base plate 22a of this embodiment does not have a reinforcement piece. A limiting portion 221a is located on the plastic second base plate 22a. The connecting member 23a of this embodiment is a connecting plate, also known as a connecting frame. One end of the connecting member 23a connects to the keycap unit 21a, and the other end connects to the limiting portion 221a of the second base plate 22a.

The elastic member 24a is also disposed on the second base plate 22a and is contacted with the keycap unit 21a. In this embodiment, the elastic member 24a is a spring, and the key module 20a comprises two elastic members 24a. Furthermore, the second base plate 22a in this embodiment also comprises a pivot 225a. The pivot 225a and the elastic member 24a are disposed on two opposite sides of the second base plate 22a, with the limiting portion 221a located between the pivot 225a and the elastic member 24a. When the connecting member 23a is assembled to the second base plate 22a, the connecting member 23a is also disposed between the pivot 225a and the elastic member 24a. As shown in FIG. 4, one side of the keycap unit 21a connects to the pivot 225a, and the other side of the keycap unit 21a is contacted with the elastic member 24a. Further, the connecting member 23a connects to a position of the keycap unit 21a that is closing to the elastic member 24a.

Because the pivot 225a and the elastic member 24a are disposed on two opposite sides of the second base plate 22a, and one side of the keycap unit 21a is fixed to the pivot 225a while the other side is contacted with the elastic member 24a, when the keycap unit 21a is not pressed, the elastic member 24a can lift one side of the keycap unit 21a upward, causing the surface of the keycap unit 21a to be inclined. The inclined surface of the keycap unit 21a is suitable for use in gaming. When the keycap unit 21a is pressed, the elastic member 24a is compressed, causing the surface of the keycap unit 21a to become flat. The connecting member 23a connects to both the second base plate 22a and the keycap unit 21a, restricting the movement height of the keycap unit 21a during its return to ensure that the elastic member 24a can contact the keycap unit 21a.

Furthermore, in this embodiment, the key module 20a also detachably connects to the fixed module 10 through the second base plate 22a (the structure of which can be referred to in FIG. 2). Specifically, the second base plate 22a has a structure similar to that of the second base plate 22 in the first embodiment. The second base plate 22a also has a propped portion 224a, and the propped portion 224a protrudes outward from the periphery of the second base plate 22a. The second base plate 22a detachably connects to the first base plate 12 through the propped portion 224a. Additionally, the key module 20a may also comprise a second magnetic member 25a, which is disposed on the second base plate 22a. The second magnetic member 25a can magnetically connects to the first magnetic member 13 located on the first circuit board 11, so that the key module 20a can be detachably connected to the fixed module 10.

Similarly, when the key module 20a is disposed on the fixed module 10, the keycap unit 21a corresponds to the accommodation space 121 of the first base plate 12, allowing the trigger unit 111 of the first circuit board 11 to sense changes in the position of the keycap unit 21a. This, in turn, generates corresponding input signals.

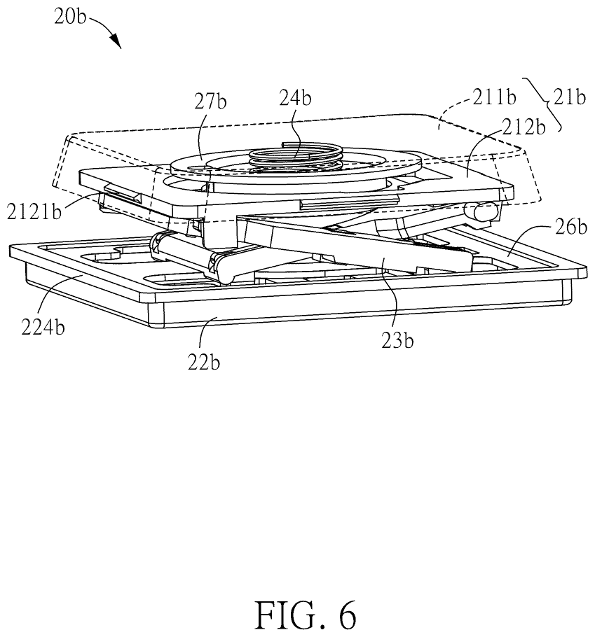

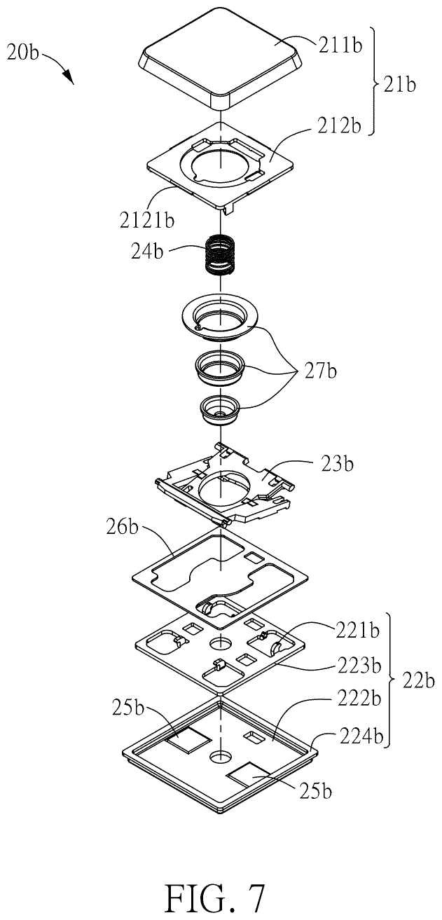

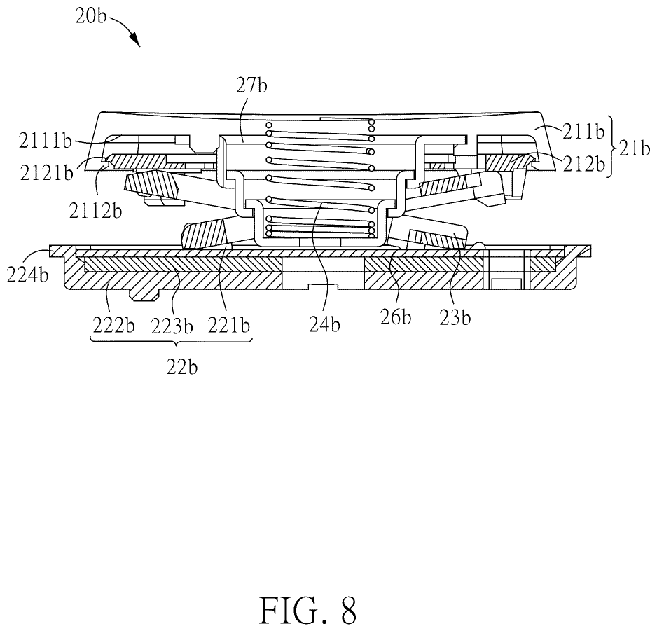

FIG. 6 is a schematic diagram of the key module in the third embodiment of the present disclosure; FIG. 7 is an exploded schematic diagram of the key module shown in FIG. 6; and FIG. 8 is a sectional schematic diagram of the key module shown in FIG. 6. Refer to FIG. 6, FIG. 7, and FIG. 8. In this embodiment, the key module 20b comprises a keycap unit 21b, a second base plate 22b, a connecting member 23b, and an elastic member 24b. In comparison to the first embodiment, the keycap unit 21b in this embodiment comprises a keycap 211b and a junction member 212b, so that the keycap unit 21b to have a longer key stroke. Specifically, the keycap 211b can movably connects to the junction member 212b. For example, the keycap 211b in this embodiment comprises a bottom surface 2111b and a first hook 2112b, as shown in FIG. 8. The first hook 2112b is spaced apart from the bottom surface 2111b. Correspondingly, the junction member 212b comprises a second hook 2121b, and the first hook 2112b and the second hook 2121b are abutted with each other, thereby maintaining a gap between the bottom surface 2111b and the junction member 212b. When the keycap 211b is pressed, the keycap 211b moves downward to engage with the junction member 212b, and the distance between the bottom surface 2111b and the junction member 212b becomes the first key stroke.

The second base plate 22b and the connecting member 23b in this embodiment are similar to those in the first embodiment. The second base plate 22b comprises a main body 222b and a reinforcement piece 223b, with the limiting portion 221b disposed on the reinforcement piece 223b. The connecting member 23b is a scissor-type connecting member, with one end connecting to the junction member 212b of the keycap unit 21b, and the other end connecting to the limiting portion 221b of the second base plate 22b. Additionally, the elastic member 24b in this embodiment is a spring, disposed on the second base plate 22b and in contact with the keycap 211b of the keycap unit 21b. Preferably, the key module 20b in this embodiment also comprises a telescopic sleeve 27b. The telescopic sleeve 27b is disposed between the second base plate 22b and the keycap 211b. The telescopic sleeve 27b in this embodiment is a three-piece component, forming a structure similar to an expandable telescopic sleeve. The elastic member 24b is accommodated in the telescopic sleeve 27b to limit its movement. When the keycap unit 21a is pressed, both the elastic member 24b and the telescopic sleeve 27b are compressed into a flat shape.

When the keycap unit 21b is pressed, the keycap 211b moves downward to contact with the junction member 212b. This movement corresponds to the first key stroke, during which the first hook 2112b separates from the second hook 2121b. Subsequently, the keycap 211b and the junction member 212b move together towards the second base plate 22b, which is the second key stroke. At this point, both the elastic member 24b and the telescopic sleeve 27b are compressed into a flat shape. When the force on the keycap unit 21b is released, the elastic member 24b provides the necessary force to return the keycap unit 21b, the connecting member 23b, and the telescopic sleeve 27b to their original positions. The lower edge of the second hook 2121b presses against the upper edge of the first hook 2112b to prevent the keycap 211b from detaching from the junction member 212b.

In other embodiments, the first hook 2112b can also engage with the second hook 2121b. In this case, the relative position of the keycap 211b and the junction member 212b is fixed. When the keycap unit 21b is pressed, the keycap 211b and the junction member 212b move together towards the second base plate 22b, with only one key stroke.

Similarly, the key module 20b in this embodiment detachably connects to the fixed module 10 (the structure of which can be referred to in FIG. 2) by the second base plate 22b. The second base plate 22b also has a propped portion 224b, with the propped portion 224b protruding outward from the periphery of the main body 222b. The key module 20b detachably connects to the first base plate 12 through the propped portion 224b. In addition, the key module 20b also comprises a second magnetic member 25b disposed on the main body 222b of the second base plate 22b. The second magnetic member 25b and the first magnetic member 13 located on the first circuit board 11 can be connected by magnetic attraction, so that the key module 20b detachably connects to the fixed module 10. When the key module 20b is installed in the fixed module 10, the keycap unit 21b corresponds to the accommodation space 121, allowing the trigger unit 111 on the first circuit board 11 to sense changes in the position of the keycap unit 21b, thereby generating corresponding input signals.

Preferably, the telescopic sleeve 27b in this embodiment can also be made of rubber material to provide a tactile feel similar to a rubber dome. Additionally, the key module 20b in this embodiment comprises a third circuit board 26b for detecting the triggering of the telescopic sleeve 27b and generating input signals. Therefore, in this embodiment, the key module 20b can choose to trigger the third circuit board 26b to generate input signals by the telescopic sleeve 27b or directly detect the position of the keycap 211b using the trigger unit 111 on the first circuit board 11 to generate input signals. In other embodiments, either the elastic member 24b or the telescopic sleeve 27b can be used, and the present disclosure is not limited thereto. For example, only a spring-based elastic member 24b can be used, and the position of the keycap 211b can be detected by the trigger unit 111 on the first circuit board 11 without the need for the telescopic sleeve 27b. Alternatively, the telescopic sleeve 27b can replace the elastic member 24b, and no additional spring-based elastic member 24b is required. The rubber material of the telescopic sleeve 27b can provide the necessary spring force to return the keycap unit 21b and the connecting member 23b to their original positions and generate input signals by the third circuit board 26b.

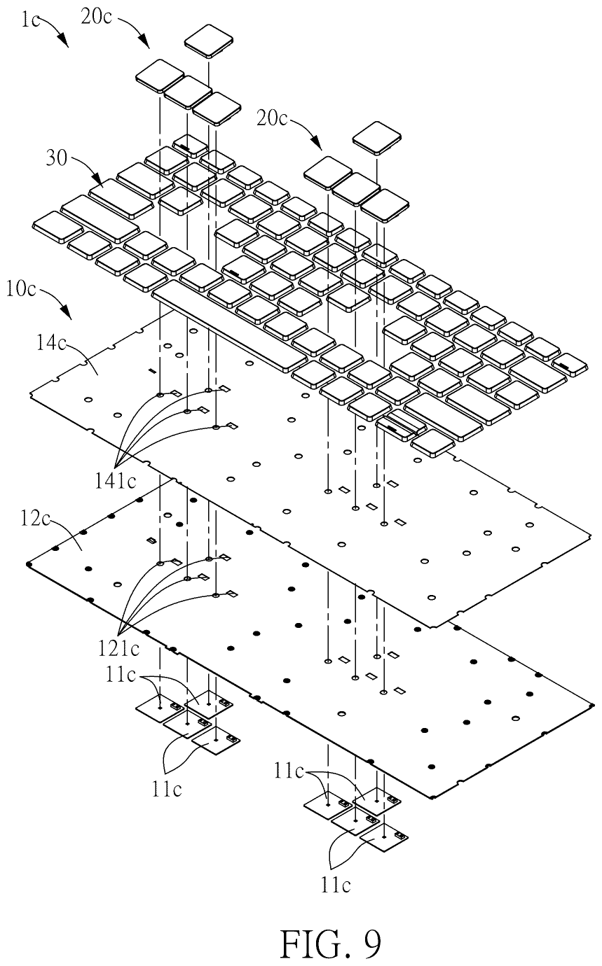

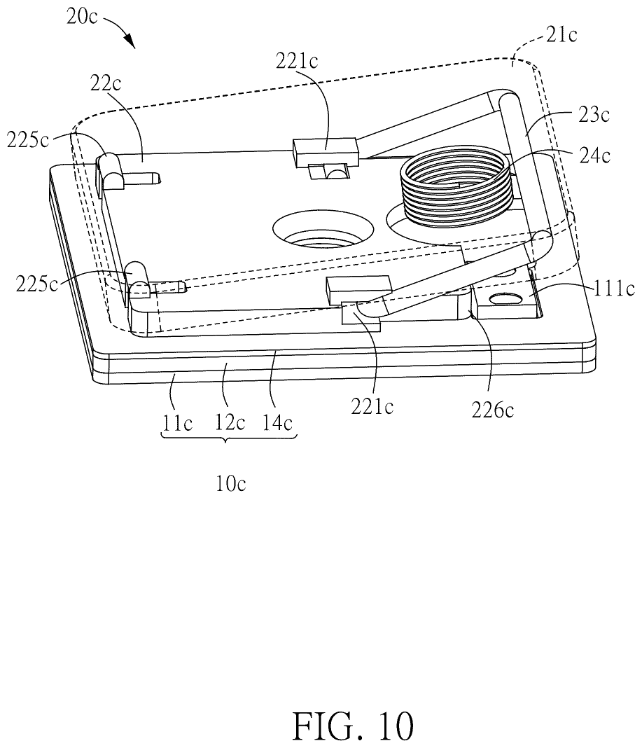

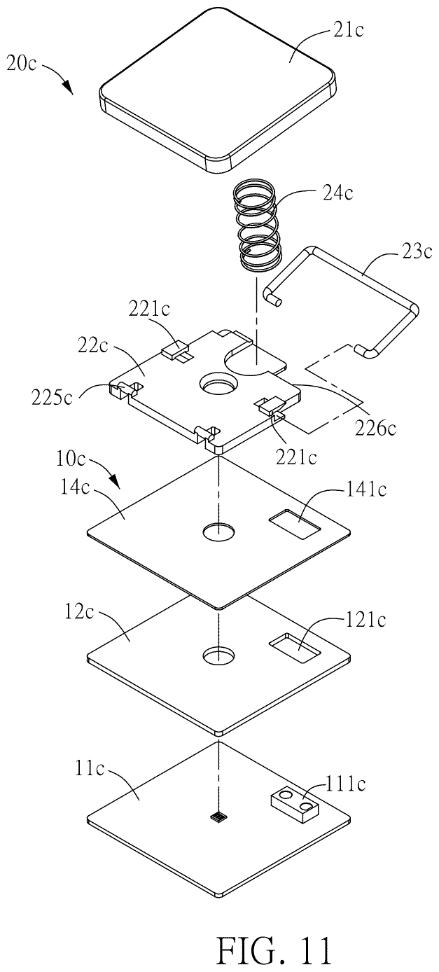

FIG. 9 is an exploded schematic diagram of the keyboard in the fourth embodiment of the present disclosure; FIG. 10 is a schematic diagram of the first circuit board and the key module shown in FIG. 9; and FIG. 11 is an exploded schematic diagram of the first circuit board and the key module shown in FIG. 10. Refer to FIG. 9, FIG. 10, and FIG. 11. In this embodiment, the keyboard 1c comprises a fixed module 10c, at least one key module 20c, and a plurality of key structures 30. The key module 20c is a replaceable key module, and the key structures 30 are of the general type. Because the key structures 30 are the same as those in the first embodiment, the same reference numerals denote the same elements. Additionally, it should be noted that the fixed module 10c in FIG. 10 and FIG. 11 only illustrate the portion corresponding to one of the key modules 20c.

In this embodiment, the fixed module 10c comprises a first circuit board 11c, a first base plate 12c, and a second circuit board 14c. The first base plate 12c has an accommodation space 121c, and the second circuit board 14c has an opening 141c. Preferably, the accommodation space 121c in this embodiment is also an opening. The first circuit board 11c comprises at least one trigger unit 111c, corresponding to individual key modules 20c. The difference from the first embodiment is that the position and shape of the accommodation space 121c and the opening 141c of this embodiment are adapted to the trigger unit 111c of the first circuit board 11c. Specifically, the trigger unit 111c is a quadrilateral and is disposed in a corner of the first circuit board 11c. Correspondingly, the positions of the trigger unit 111c projecting orthogonally onto the first base plate 12c and the second circuit board 14c form a quadrangular accommodation space 121c and an opening 141c, respectively. Thus, the trigger unit 111c can pass through the accommodation space 121c of the first base plate 12c and the opening 141c of the second circuit board 14c.

The key module 20c in this embodiment can be detachably disposed on the fixed module 10c. For example, cooperating locking structures can be set between the fixed module 10c and the key module 20c to allow the key module 20c to be disposed on the fixed module 10c in a locking manner. Alternatively, magnetic members that attract each other can be set between the fixed module 10c and the key module 20c to allow the key module 20c to be disposed on the fixed module 10c in a magnetic manner. Regarding the specific implementation of detachably connecting the key module 20c to the fixed module 10c, reference can be made to the previous embodiments, and no further details are provided here.

In this embodiment, the key module 20c also has an inclined surface when not pressed, which is suitable for gaming. The key module 20c comprises a keycap unit 21c, a second base plate 22c, a connecting member 23c, and an elastic member 24c. In comparison to the first embodiment, the second base plate 22c in this embodiment does not have a reinforcement piece, and the limiting portion 221c is located at the plastic second base plate 22c and in the middle of the second base plate 22c. The connecting member 23c in this embodiment is a linkage, as shown in FIG. 10 and FIG. 11. One end of the connecting member 23c connects to the keycap unit 21c, and the other end connects to the limiting portion 221c of the second base plate 22c.

The elastic member 24c in this embodiment is a spring, disposed on the second base plate 22c and in contact with the keycap unit 21c. Similar to the second embodiment, the second base plate 22c of this embodiment further comprises a pivot 225c. The pivot 225c and the elastic member 24c are disposed on two opposite sides of the second base plate 22c. Because the limiting portion 221c is located between the pivot 225b and the elastic member 24c, so that the connecting member 23c is also located between the pivot 225c and the elastic member 24c. One side of the keycap unit 21c connects to the pivot 225c, and the other side connects to the connecting member 23c. When the keycap unit 21c is not pressed, the elastic member 24c can push up one side of the keycap unit 21c to create the inclined surface, as shown in FIG. 10. The inclined surface of the keycap 211b is suitable for gaming.

As previously mentioned, the trigger unit 111c in this embodiment is disposed in a corner of the first circuit board 11c. Correspondingly, the elastic member 24c can be disposed in the center of one side of the second base plate 22c, and one corner of the second base plate 22c may be a recess 226c. The trigger unit 111c in this embodiment passes through the accommodation space 121c of the first base plate 12c and the opening 141c of the second circuit board 14c, and the trigger unit 111c can be accommodated in the recess 226c of the second base plate 22c. In other embodiments, the recess 226c can be a hole structure, and the present disclosure is not limited thereto. Because the keycap unit 21c partially corresponds to the accommodation space 121c of the first base plate 12c and the opening 141c of the second circuit board 14c, so that the trigger unit 111c can detect changes in the position of the keycap unit 21c and generate corresponding input signals.

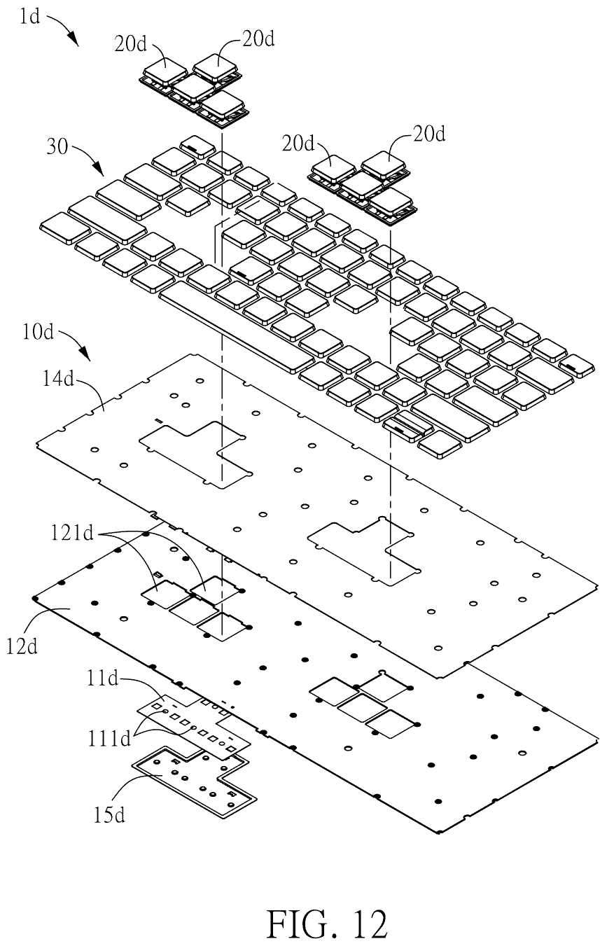

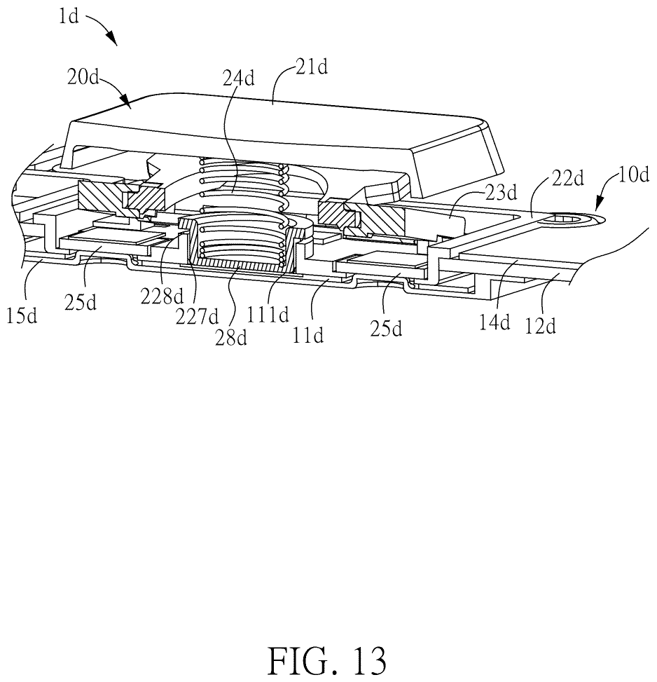

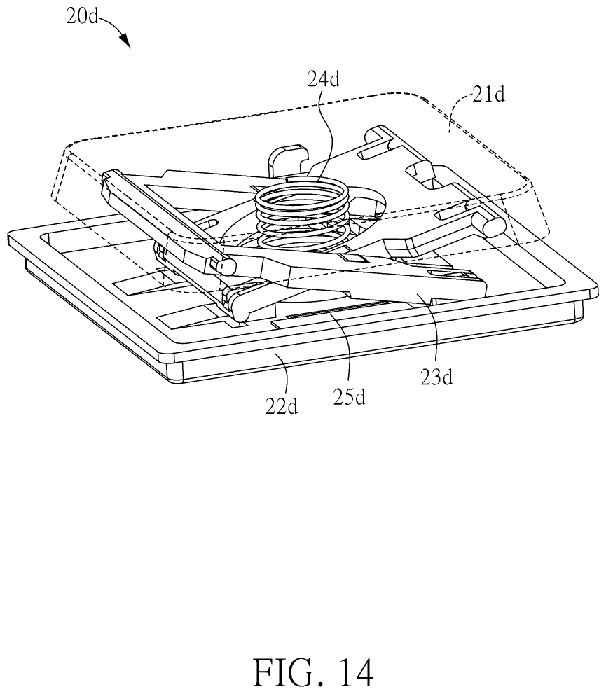

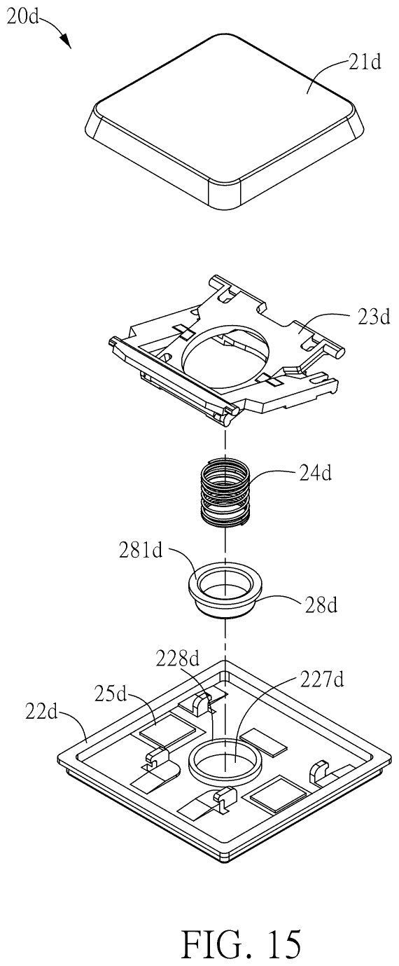

FIG. 12 is an exploded schematic diagram of the keyboard of the fifth embodiment of the present disclosure; FIG. 13 is a sectional schematic diagram of the keyboard shown in FIG. 12 after assembly, illustrating one of the key modules; FIG. 14 is a schematic diagram of the key module shown in FIG. 12; and FIG. 15 is an exploded schematic diagram of the key module shown in FIG. 14. Refer to FIG. 12, FIG. 13, FIG. 14, and FIG. 15. The keyboard 1d of this embodiment includes a fixed module 10d, at least one key module 20d, and a plurality of key structures 30. The key module 20d is a replaceable key module, and the key structure 30 is a general type of key structure. Because the key structure 30 is the same as in the first embodiment, the same reference numerals denote the same elements. The key module 20d is also detachably disposed on the fixed module 10d in locking manner or in magnetic manner.

The fixed module 10d of this embodiment also comprises a first circuit board 11d, a first base plate 12d, and a second circuit board 14d. The first base plate 12d has an accommodation space 121d, which is an opening. In this embodiment, the accommodation space 121d can correspond to adjacent multiple key modules 20d. Preferably, the fixed module 10d of this embodiment further comprises a bracket 15d. The bracket 15d is disposed on a surface of the first base plate 12d opposite to the key module 20d and corresponds to the accommodation space 121d. Further, the bracket 15d is to be disposed on the first base plate 12d using, for example, but not limited to, adhesive bonding, snap fitting, welding, or other appropriate connection means. In this embodiment, the profile of the bracket 15d is almost the same as the profile of the accommodation space 121d, and the present disclosure is not limited thereto. When the bracket 15d is disposed on the first base plate 12d, the bracket 15d can cover the accommodation space 121d.

Furthermore, the first circuit board 11d is disposed on a surface of the bracket 15d facing the key module 20d. In other words, the bracket 15d can be used to support the first circuit board 11d, as shown in FIG. 13. Preferably, the bracket 15d and the key module 20d in this embodiment are connected by magnetic attraction, so that the key module 20d can be detachably secured to the fixed module 10d. Specifically, the bracket 15d of this embodiment can be a magnetic material, such as a metal member. Correspondingly, the key module 20d of this embodiment also comprises a second magnetic member 25d, which is disposed on the second base plate 22d and near the bottom surface. When the key module 20d is placed in the accommodation space 121d of the first base plate 12d, the second magnetic member 25d can be mutually attracted to the bracket 15d, so that the bracket 15d and the key module 20d can be connected to each other by magnetic attraction.

The first circuit board 11d comprises at least one trigger unit 111d corresponding to each key module 20d. In contrast to the previous embodiments, the trigger unit 111d of this embodiment is a force sensor, which is also disposed on the first circuit board 11d. In this embodiment, the first circuit board 11d can be a membrane circuit board, and the trigger unit 111d (i.e., the force sensor) can be a membrane switch, to detect whether the key module 20d is pressed. The second circuit board 14d also includes a plurality of membrane switches, to detect whether the key structures 30 are pressed.

The key module 20d of this embodiment also includes a keycap unit 21d, a second base plate 22d, a connecting member 23d, and an elastic member 24d. The connecting member 23d is a scissor-type connecting member, with one end connecting to the keycap unit 21d and the other end connecting to the second base plate 22d. In this embodiment, the elastic member 24d can be a spring, and the elastic member 24d is disposed on the second base plate 22d. In this embodiment, the second base plate 22d also comprises an accommodating hole 227d, and the accommodating hole 227d corresponds to the elastic member 24d, as shown in FIG. s 13 and FIG. 15. Specifically, one end of the elastic member 24d is in contact with the keycap unit 21d, and the other end is located in the accommodating hole 227d of the second base plate 22d. Furthermore, the trigger unit 111d (i.e., the force sensor) of this embodiment is disposed below the accommodating hole 227d to receive the force exerted on the elastic member 24d when pressed down, thereby generating a trigger signal. In one embodiment, the elastic member 24d may directly contact the trigger unit 111d (i.e., the force sensor). Therefore, when the keycap unit 21d is pressed, the elastic member 24d is compressed by the downward force, and the force transmit to the trigger unit 111d (i.e., the force sensor) located below the accommodating hole 227d and the elastic member24d. The upper layer of trigger unit 111d (i.e., the force sensor) undergoes deformation, causing the upper circuit to contact with the lower circuit, leading to conduction, and generating the corresponding input signals. In other embodiments, the trigger unit 111d may be another type of force sensor used to detect changes in the force applied to the elastic member 24d. It generates a corresponding trigger signal when the keycap unit 21d is pressed.

Preferably, the key module 20d of this embodiment further comprises a fixed member 28d, which is disposed in the accommodating hole 227d of the second base plate 22d. The fixed member 28d is used to accommodate or support the elastic member 24d. As shown in FIG. s 13 and FIG. 15, the fixed member 28d of this embodiment is a cover structure, such as a U-shaped cover structure. Furthermore, the fixed member 28d (i.e., the cover structure) is disposed in the accommodating hole 227d, with the opening of the fixed member 28d facing the keycap unit 21d, and the bottom surface of the fixed member 28d facing the trigger unit 111d of the first circuit board 11d. Furthermore, the elastic member 24d is accommodated in the fixed member 28d (i.e., the cover structure). Therefore, when the keycap unit 21d is pressed, the downward force can be transmitted through the elastic member 24d to the bottom surface of the fixed member 28d, and then transmitted to the trigger unit 111d. This causes the trigger unit 111d (i.e., the force sensor) to deform and conduct, generating a corresponding input signal. Because the area of the bottom surface of the fixed member 28d is greater than the area of one end of the elastic member 24d, it can enhance the sensitivity of triggering the trigger unit 111d (i.e., the force sensor). Additionally, through the design of the fixed member 28d, it can provide support for the elastic member 24d when replacing the key module 20d, preventing the elastic member 24d from protruding externally during the replacement of the key module 20d, thus maintaining the overall integrity of the key module 20d.

In this embodiment, the periphery of the accommodating hole 227d has a sidewall extending upward from the second base plate 22d, so that the accommodating hole 227d has a sidewall top surface 228d. Correspondingly, the fixed member 28d (i.e., the cover structure) has an extending portion 281d formed by extending outward. When the fixed member 28d is disposed in the accommodating hole 227d, the extending portion 281d is located above the sidewall top surface 228d, preventing the fixed member 28d from moving excessively downward. Preferably, there is a gap between the extending portion 281d and the sidewall top surface 228d, providing a buffer space for the fixed member 28d to move up and down, thereby preventing the fixed member 28d from continuously contacting the trigger unit 111d (i.e., the force sensor), thereby enhancing the sensing effect.

Additionally, in this embodiment, the accommodating hole 227d is located at the central position of the second base plate 22d. In other embodiments, the accommodating hole 227d may be located on one side of the second base plate 22d, and the present disclosure is not limited thereto. Furthermore, a pivot may be provided on the other side of the second base plate 22d compared to the accommodating hole 227d, and the connecting member 23d can correspondingly be a linkage or connecting plate, allowing the keycap unit 21d to form an inclined surface suitable for gaming.

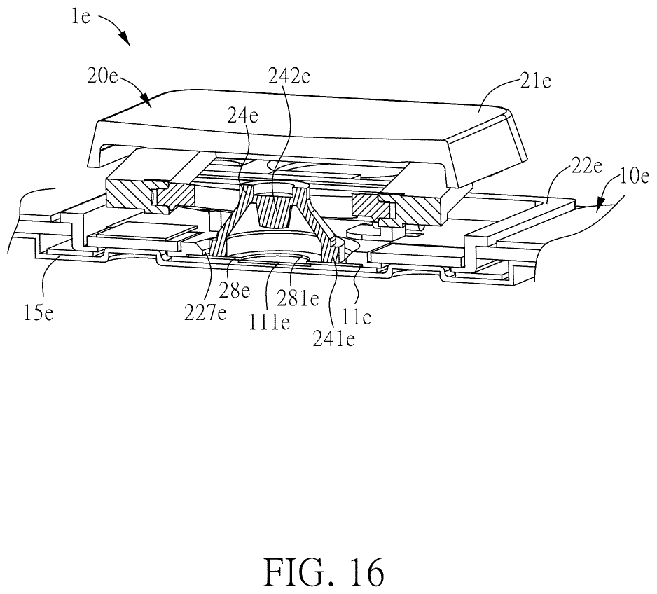

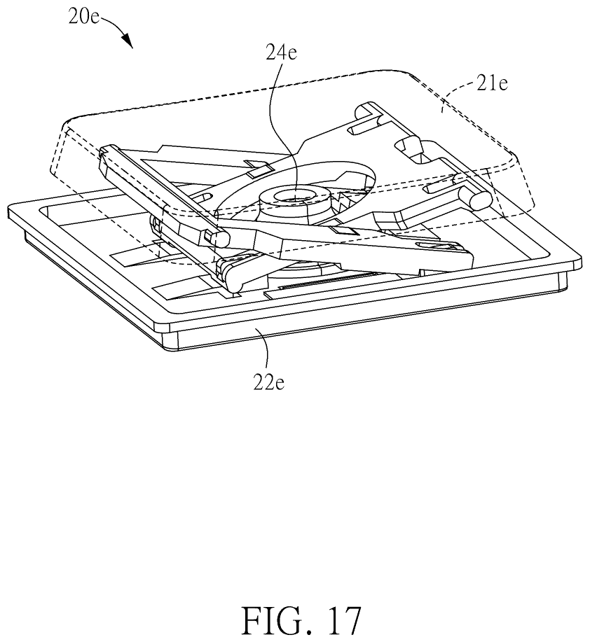

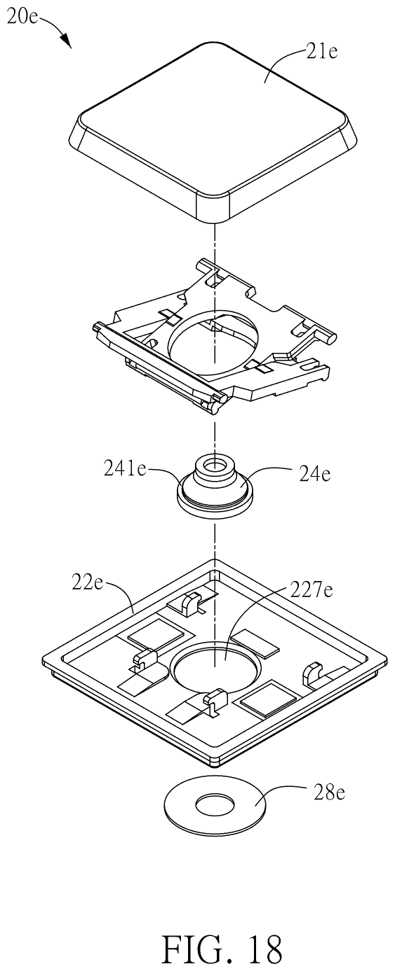

FIG. 16 is a sectional schematic diagram of a partial keyboard of the sixth embodiment of the present disclosure; FIG. 17 is a schematic diagram of the key module shown in FIG. 16; and FIG. 18 is an exploded schematic diagram of the key module shown in FIG. 16. Refer to FIG. 16, FIG. 17, and FIG. 18. The keyboard 1e of this embodiment comprises a fixed module 10e and a replaceable key module 20e. The trigger unit 111e of the first circuit board 11e is also a force sensor, such as a membrane switch. Furthermore, the fixed module 10e also has a bracket 15e, which is used to support the first circuit board 11e. The key module 20e of this embodiment differs mainly in the elastic member 24e and the fixed member 28e. Specifically, the elastic member 24e of this embodiment is a rubber dome and is disposed in the accommodating hole 227e of the second base plate 22e. The elastic member 24e (i.e., the rubber dome) has a bottom 241e and a trigger portion 242e. When the elastic member 24e is not deformed, the trigger portion 242e is suspended and faces the trigger unit 111e (i.e., the force sensor).

In one embodiment, the bottom 241e of the elastic member 24e may be directly disposed on the first circuit board 11e, so that the trigger portion 242e corresponds to the trigger unit 111e (i.e., the force sensor). When the keycap unit 21e is pressed, the elastic member 24e is deformed and causes the trigger portion 242e to contact the trigger unit 111e. At this time, the upper layer of the trigger unit 111e (i.e., the force sensor) undergoes deformation, causing the upper circuit to contact with the lower circuit, leading to conduction, and generating the corresponding input signal.

Preferably, the key module 20e of this embodiment also comprises a fixed member 28e. The fixed member 28e of this embodiment is a fixed film, which may be, but not limited to, Mylar. The fixed member 28e (i.e., the fixed film) connects to a surface of the second base plate 22e facing the first circuit board 11e and covers at least a portion of the accommodating hole 227e. Specifically, the fixed member 28e has an opening 281e. When the fixed member 28e connects to the bottom surface of the first circuit board 11e, the opening 281e corresponds to the trigger portion 242e of the elastic member 24e, and the other parts of the fixed member 28e cover the accommodating hole 227e. In this embodiment, the bottom 241e of the elastic member 24e can be placed directly on the fixed member 28e (i.e., the fixed film), and the trigger portion 242e corresponds to the opening 281e. When the keycap unit 21e is pressed, the elastic member 24e deforms, causing the trigger portion 242e to move downward and contact the trigger unit 111e.

The present disclosure provides a key module for use in a keyboard. The keyboard comprises a fixed module, and the key module can be detachably installed in the fixed module. Details regarding the components of the fixed module and the key module, as well as their interconnections, can be found in the previous embodiments and are not elaborated upon here.

In summary, according to the keyboard and key module applied to the keyboard of this disclosure, the keyboard comprises a fixed module and at least one said key module. The fixed module comprises a first circuit board and a first base plate. The first circuit board comprises a trigger unit, and the first base plate comprises an accommodation space. Additionally, the key module comprises a keycap unit and a second base plate. The trigger unit and a portion of the keycap unit correspond to the accommodation space, allowing the trigger unit to sense the displacement of the keycap unit and generate a trigger signal. Furthermore, the key module detachably connects to the fixed module via the second base plate, so that the key module can be a replaceable key module. Therefore, the keyboard of this disclosure can accommodate different usage needs by replacing with different key modules, thereby improving the user experience.

Although the present disclosure has been explained in relation to its preferred embodiments, it is to be understood that many other possible modifications and variations can be made without departing from the spirit and scope of the disclosure as hereinafter claimed.

What is claimed is:

1. A keyboard, comprising:
a fixed module, comprising:
a first circuit board, comprising a trigger unit; and
a first base plate, comprising an accommodation space, the trigger unit corresponding to the accommodation space; and
at least one key module, detachably disposed on the fixed module, the key module comprising:
a keycap unit, partially corresponding to the accommodation space of the first base plate;
a second base plate, detachably connecting to the fixed module, wherein the second base plate comprises an accommodating hole;
a connecting member, one end connecting to the keycap unit, the other end connecting to the second base plate; and
an elastic member disposed on the second base plate, corresponding to the accommodating hole, and in contact with the keycap unit.

2. The keyboard as claimed in claim 1, wherein the second base plate detachably connects to the first base plate.

3. The keyboard as claimed in claim 2, wherein the fixed module and the key module are connected by magnetic attraction.

4. The keyboard as claimed in claim 1, wherein the trigger unit is a force sensor disposed below the accommodating hole.

5. The keyboard as claimed in claim 1, wherein the key module further comprises a fixed member disposed in the accommodating hole of the second base plate, and a portion of the elastic member is in contact with the fixed member.

6. The keyboard as claimed in claim 5, wherein the fixed member is a cover structure disposed within the accommodating hole.

7. The keyboard as claimed in claim 6, wherein the accommodating hole has a sidewall top surface, the cover structure has an extending portion extending outward and disposed above the sidewall top surface, and there is a gap between the extending portion and the sidewall top surface.

8. The keyboard as claimed in claim 6, wherein the fixed member is a U-shaped cover structure having an opening of the fixed member facing the keycap unit, and a bottom surface of the fixed member facing the trigger unit of the first circuit board.

9. The keyboard as claimed in claim 8, wherein when the keycap unit is pressed, a downward force is transmitted through the elastic member to the bottom surface of the fixed member, and then transmitted to the trigger unit then causing the trigger unit to deform and conduct to generate a corresponding input signal.

10. The keyboard as claimed in claim 8, wherein an area of the bottom surface of the fixed member is greater than an area of one end of the elastic member.

11. The keyboard as claimed in claim 1, wherein the elastic member is a spring.

12. The keyboard as claimed in claim 1, wherein the first circuit board is a membrane circuit board and the trigger unit is a membrane switch.

13. The keyboard as claimed in claim 1, wherein the fixed module 10d further comprises a bracket disposed on a surface of the first base plate opposite to the key module and corresponding to the accommodation space.

14. The keyboard as claimed in claim 13, wherein when the bracket is disposed on the first base plate, the bracket covers the accommodation space.

15. The keyboard as claimed in claim 13, wherein the bracket and the key module are connected by magnetic attraction.

16. The keyboard as claimed in claim 1, wherein the connecting member is a scissor-type connecting member.

17. The keyboard as claimed in claim 16, wherein one end of the elastic member is in contact with the keycap unit, and the other end is located in the accommodating hole of the second base plate.

18. A key module, being applied to a keyboard, the keyboard comprising a fixed module,
and the fixed module comprising a first base plate, wherein the key module is detachably disposed on the fixed module, and the key module comprises:
a keycap unit, partially corresponding to an accommodation space of the first base plate;
a second base plate, detachably connecting to the fixed module, wherein the second base plate comprises an accommodating hole;
a connecting member, one end connecting to the keycap unit, the other end connecting to the second base plate; and
an elastic member disposed on the second base plate, corresponding to the accommodating hole, and in contact with the keycap unit.
